(19) United States
(12) Patent Application Publication
(10) Pub. No.: US 2025/0337000 A1
(43) Pub. Date: Oct. 30, 2025

(54) Method for Manufacturing Vanadium Electrolyte

(71) Applicant: HONG JING METAL CORPORATION, Pingtung County (TW)

(72) Inventors: YU-LUNG SUN, Pingtung County (TW); MING-ZHE TSAI, Pingtung County (TW); YUNG-HAO LIU, Pingtung County (TW)

(21) Appl. No.: 18/757,578

(22) Filed: Jun. 28, 2024

(30) Foreign Application Priority Data
Apr. 25, 2024 (TW) 113115502

(51) Int. Cl. H01M 8/18; C01G 31/00

(52) U.S. Cl. CPC H01M 8/188; C01G 31/006; H01M 8/182; C01P 2006/80; H01M 2300/0011

(57) ABSTRACT

A method for manufacturing a vanadium electrolyte is used to solve the problem that the expansive raw material and the additional reducing agent are used in the conventional method. The method comprises: preforming a reduction roasting reaction of ammonium trioxovanadate (V) (NH₄VO₃) at a temperature of 700° C. to 900° C. for a time period of 1 hour to 4 hours to obtain a first vanadium-containing mixture. The first vanadium-containing mixture is dissolved in a first aqueous sulfuric acid solution to obtain the vanadium electrolyte. Accordingly, the manufacturing cost of the vanadium electrolyte is reduced, and the quality of the vanadium electrolyte is improved.

### CROSS REFERENCE TO RELATED APPLICATIONS

The application claims the benefit of Taiwan application serial No. 113115502, filed Apr. 25, 2024, the subject matter of which is incorporated herein by reference.

### BACKGROUND OF THE INVENTION

### 1. Field of the Invention

The present invention generally relates to a method for manufacturing an electrolyte and, more particularly, to a method for manufacturing a vanadium electrolyte.

### 2. Description of the Related Art

Vanadium redox battery (VFB), also known as vanadium redox flow battery (VRFB), is a rechargeable flow battery that stores chemical potential energy by vanadium ions in different oxidation states. Vanadium redox batteries are suitable for large-scale power storage due to their extremely large energy capacity.

Vanadium redox batteries use vanadium electrolyte as the electrolyte; and therefore, the performance of vanadium electrolyte is crucial to the development of vanadium redox batteries. For example, Chinese Patent Publication No. 101562256 discloses a conventional method for manufacturing the vanadium electrolyte. In the conventional method, vanadium (V) oxide (V₂O₅) is used as the raw material, and concentrated sulfuric acid (the aqueous sulfuric acid solution with a sulfuric acid concentration of 98%) is used to dissolve vanadium (V) oxide (V₂O₅). After vanadium (V) oxide (V₂O₅) is dissolved, the reducing agents such as 2-methyl-1-propanol, ethanedioic acid, but-2-ene, butanal and propane-1,3-diol are further added to form the vanadium electrolyte. However, expansive vanadium (V) oxide (V₂O₅) is used as the raw material in the conventional method for manufacturing the vanadium electrolyte (approximately NT$4,000 per kilogram), and the use of the reducing agents also cause impurity problems, thereby increasing the manufacturing cost of the vanadium electrolyte.

Accordingly, the conventional method for manufacturing the vanadium electrolyte should be improved.

### SUMMARY OF THE INVENTION

It is therefore an objective of the present invention to provide a method for manufacturing a vanadium electrolyte using a relative cheap vanadium-containing compound as a raw material.

It is another objective of the present invention to provide a method for manufacturing a vanadium electrolyte without additional reducing agents.

As used herein, the term “a”, “an” or “one” for describing the number of the elements and members of the present invention is used for convenience, providing the general meaning of the scope of the present invention, and should be interpreted to include one or at least one. Furthermore, unless explicitly indicated otherwise, the concept of a single component also includes the case of plural components.

One embodiment of the present invention discloses a method for manufacturing a vanadium electrolyte, which comprises: carrying out a reduction roasting reaction of ammonium trioxovanadate (V) (NH₄VO₃) at a temperature of from 700° C. to 900° C. for a time period of 1 hour to 4 hours, obtaining a vanadium-containing mixture; and dissolving the vanadium-containing mixture in an aqueous sulfuric acid solution to obtain the vanadium electrolyte.

Accordingly, in the method for manufacturing the vanadium electrolyte according to the present invention, by the use of ammonium trioxovanadate (V) (NH₄VO₃), which is cheaper than vanadium (V) oxide (V₂O₅), vanadium (IV) oxide (V₂O₄) and/or vanadium (III) oxide (V₂O₃) can be formed by the reduction roasting reaction. Vanadium (IV) oxide (V₂O₄) and/or vanadium (III) oxide (V₂O₃) can be further dissolved in the aqueous sulfuric acid solution to form the vanadium electrolyte. As such, the manufacturing cost of the vanadium electrolyte can be reduced. Moreover, vanadium (V) oxide (V₂O₅) formed by heating ammonium trioxovanadate (V) (NH₄VO₃) can be reduced by ammonia gas (NH_{3(g)}) formed by heating ammonium trioxovanadate (V) (NH₄VO₃) as the reducing agent, and thus, no additional reducing agent is required in the method for manufacturing the vanadium electrolyte according to the present invention. Therefore, it is possible to avoid the impurities caused by the addition of additional reducing agents, and thereby improving the quality of the vanadium electrolyte.

In the method for manufacturing the vanadium electrolyte according to the present invention, the reduction roasting can be carried out at a temperature equal to or greater than 800° C. Alternatively, the reduction roasting can be carried out for a time period of equal to or greater than 3 hours. Preferably, the reduction roasting can be carried out at a temperature of 850° C. for a time period of 3 hours. As such, it can ensure that the obtained vanadium-containing mixture contains the highest proportion of vanadium (III) oxide (V₂O₃) among all vanadium-containing compounds.

In the method for manufacturing the vanadium electrolyte according to the present invention, the aqueous sulfuric acid solution can have a sulfuric acid concentration of from 3 M to 6 M. Preferably, the aqueous sulfuric acid solution can have a sulfuric acid concentration of equal to or greater than 4 M. As such, the solubility of the vanadium-containing mixture in the aqueous sulfuric acid solution can be improved.

In the method for manufacturing the vanadium electrolyte according to the present invention, the vanadium-containing mixture can be dissolved in the aqueous sulfuric acid solution at a temperature of from 60° C. to 90° C. Preferably, the vanadium-containing mixture can be dissolved in the aqueous sulfuric acid solution at a temperature of equal to or greater than 80° C. As such, the solubility of the vanadium-containing mixture in the aqueous sulfuric acid solution can be improved.

In the method for manufacturing the vanadium electrolyte according to the present invention, the vanadium-containing mixture can be dissolved in the aqueous sulfuric acid solution for a time period of from 1 hour to 5 hours. Preferably, the vanadium-containing mixture can be dissolved in the aqueous sulfuric acid solution for a time period of equal to or greater than 3 hours. As such, the solubility of the vanadium-containing mixture in the aqueous sulfuric acid solution can be improved.

Another embodiment of the present invention discloses a method for manufacturing a vanadium electrolyte, which comprises: carrying out a first reduction roasting reaction of ammonium trioxovanadate (V) (NH₄VO₃) at a temperature of from 700° C. to 900° C. for a time period of from 1 hour to 4 hours, obtaining a first vanadium-containing mixture; dissolving the first vanadium-containing mixture in a first aqueous sulfuric acid solution, obtaining a first vanadium-containing solution; carrying out a second reduction roasting reaction of ammonium trioxovanadate (V) (NH₄VO₃) at a temperature of from 500° C. to 700° C. for a time period of from 1 hour to 4 hours, obtaining a second vanadium-containing mixture; dissolving the second vanadium-containing mixture in a second aqueous sulfuric acid solution, obtaining a second vanadium-containing solution; and mixing the first vanadium-containing solution and the second vanadium-containing solution to obtain the vanadium electrolyte.

Accordingly, in the method for manufacturing the vanadium electrolyte according to the present invention, by the preferential preparation of the first vanadium-containing solution and the second vanadium-containing solution, it can be ensured that the first vanadium-containing solution and the second vanadium-containing solution contain vanadium (III) oxide (V₂O₃) and vanadium (IV) oxide (V₂O₄), respectively. Therefore, the vanadium electrolyte can be obtained by further mixing the first vanadium-containing solution and the second vanadium-containing solution, thereby improving the manufacturing efficiency of the vanadium electrolyte.

The method for manufacturing the vanadium electrolyte according to the present invention can further comprise: measuring average valence of the vanadium ion of the first vanadium-containing solution and average valence of the vanadium ion of the second vanadium-containing solution to calculate a predetermined mixing ratio between the first vanadium-containing solution and the second vanadium-containing solution; and mixing the first vanadium-containing solution and the second vanadium-containing solution according to the predetermined mixing ratio to obtain the vanadium electrolyte. As such, by preferentially calculating the predetermined mixing ratio, the vanadium electrolyte with an average valence of the vanadium ion of 3.5 can be obtained, thereby improving the manufacturing yield of the vanadium electrolyte.

In the method for manufacturing the vanadium electrolyte according to the present invention, the first reduction roasting reaction can be carried out at a temperature of equal to or greater than 800° C. Alternatively, the first reduction roasting reaction can be carried out for a time period of equal to or greater than 3 hours. Preferably, the first reduction roasting reaction can be carried out at a temperature of 850° C. for a time period of 3 hours. As such, it can ensure that the obtained first vanadium-containing mixture contains the highest proportion of vanadium (III) oxide (V₂O₃) among all vanadium-containing compounds.

In the method for manufacturing the vanadium electrolyte according to the present invention, the first aqueous sulfuric acid solution can have a sulfuric acid concentration of from 3 M to 6 M. Preferably, the first aqueous sulfuric acid solution can have a sulfuric acid concentration of equal to or greater than 4 M. As such, the solubility of the first vanadium-containing mixture in the first aqueous sulfuric acid solution can be improved.

In the method for manufacturing the vanadium electrolyte according to the present invention, the first vanadium-containing mixture can be dissolved in the first aqueous sulfuric acid solution at a temperature of from 60° C. to 90° C. Preferably, the first vanadium-containing mixture can be dissolved in the first aqueous sulfuric acid solution at a temperature of equal to or greater than 80° C. As such, the solubility of the first vanadium-containing mixture in the first aqueous sulfuric acid solution can be improved.

In the method for manufacturing the vanadium electrolyte according to the present invention, the first vanadium-containing mixture is dissolved in the first aqueous sulfuric acid solution for a time period of from 1 hour to 5 hours. Preferably, the first vanadium-containing mixture is dissolved in the first aqueous sulfuric acid solution for a time period of equal to or greater than 3 hours. As such, the solubility of the first vanadium-containing mixture in the first aqueous sulfuric acid solution can be improved.

In the method for manufacturing the vanadium electrolyte according to the present invention, the second reduction roasting reaction can be carried out at a temperature of equal to or greater than 600° C. Alternatively, the second reduction roasting reaction can be carried out for a time period of equal to or greater than 2 hours. Preferably, the second reduction roasting reaction can be carried out at a temperature of 650° C. for a time period of 2 hours. As such, it can ensure that the obtained second vanadium-containing mixture contains the highest proportion of vanadium (IV) oxide (V₂O₄) among all vanadium-containing compounds.

In the method for manufacturing the vanadium electrolyte according to the present invention, the second aqueous sulfuric acid solution can have a sulfuric acid concentration of from 3 M to 6 M. Preferably, the second aqueous sulfuric acid solution can have a sulfuric acid concentration of equal to or greater than 4 M. As such, the solubility of the second vanadium-containing mixture in the second aqueous sulfuric acid solution can be improved.

In the method for manufacturing the vanadium electrolyte according to the present invention, the second vanadium-containing mixture can be dissolved in the second aqueous sulfuric acid solution at a temperature of from 60° C. to 90° C. Preferably, the second vanadium-containing mixture can be dissolved in the second aqueous sulfuric acid solution at a temperature of equal to or greater than 80° C. As such, the solubility of the second vanadium-containing mixture in the second aqueous sulfuric acid solution can be improved.

In the method for manufacturing the vanadium electrolyte according to the present invention, the second vanadium-containing mixture can be dissolved in the second aqueous sulfuric acid solution for a time period of from 1 hour to 4 hours. Preferably, the second vanadium-containing mixture can be dissolved in the second aqueous sulfuric acid solution for a time period of equal to or greater than 2 hours. As such, the solubility of the second vanadium-containing mixture in the second aqueous sulfuric acid solution can be improved.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 depicts a flow chart of a method for manufacturing a vanadium electrolyte according to a first embodiment of the present invention.

FIG. 2 depicts a flow chart of a method for manufacturing a vanadium electrolyte according to a second embodiment of the present invention.

### DETAILED DESCRIPTION OF THE INVENTION

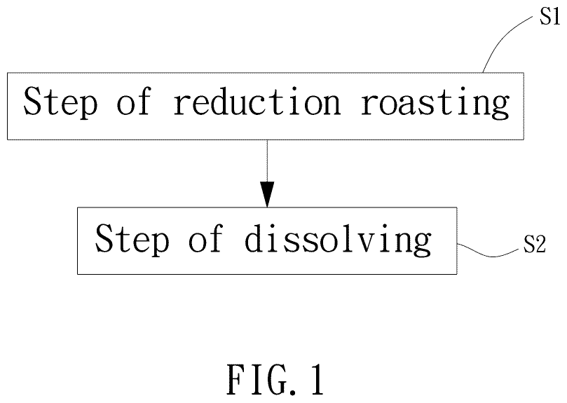

Referring to FIG. 1, a method for manufacturing a vanadium electrolyte according to a first embodiment of the present invention can generally comprise a step of reduction roasting S1 and step of dissolving S2, whereby ammonium trioxovanadate (V) (NH₄VO₃) as a raw material to produce a vanadium electrolyte. The vanadium electrolyte contains vanadium (III) ion (V³⁺), vanadium (IV) ion (V⁴⁺; in the form of vanadyl ion (VO²⁺)) and sulfate ion (SO₄²⁻). In the vanadium electrolyte, the molar ratio of vanadium (III) ion (V³⁺) and vanadium (IV) ion (V⁴⁺) is approximately between 1:1 and 1.1:1. In other words, vanadium ions contain 50-53% of vanadium (III) ion (V³⁺) and 47-50% of vanadium (IV) ion (V⁴⁺) in molar percentage. Moreover, in the vanadium electrolyte, the total concentration of vanadium (III) ion (V³⁺) and vanadium (IV) ion (V⁴⁺) is between 1.6 M and 1.8 M, and the concentration of the sulfate ion (SO₄²⁻) is between 2.5 M to 3 M.

Specifically, in the step of reduction roasting S1, ammonium trioxovanadate (V) (NH₄VO₃) is placed in a reduction furnace. The oxygen concentration in the reduction furnace is close to 0%, and a reduction roasting reaction is carried out in an anaerobic environment. In the reduction roasting reaction, ammonium trioxovanadate (V) (NH₄VO₃) is heated to generate vanadium (V) oxide (V₂O₅₍ₛ₎) and ammonia gas (NH_{3(g)}) as shown in chemical equation (I). Moreover, according to chemical equations (II) and (III), the generated ammonia gas (NH_{3(g)}) can reduce vanadium (V) oxide (V₂O₅) to form vanadium (IV) oxide (V₂O₄₍ₛ₎) and/or vanadium (III) oxide (V₂O₃₍ₛ₎), and a vanadium-containing mixture can be obtained.

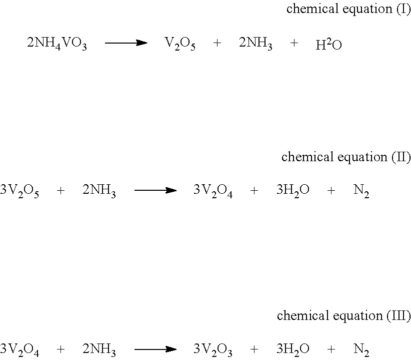

In addition, by adjusting the parameters, the vanadium-containing mixture containing vanadium (IV) oxide (V₂O₄) and vanadium (III) oxide (V₂O₃) with a molar ratio of approximately 1:1 can be formed according to chemical equation (IV). In the first embodiment of the present invention, the reduction roasting reaction can be carried out at a temperature of from 700° C. to 900° C. for a time period of from 1 hour to 4 hours. Preferably, the reduction roasting reaction can be carried out at a temperature of equal to or greater than 800° C., or the reduction roasting reaction can be carried out for a time period of equal to or greater than 3 hours.

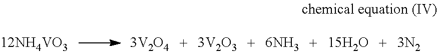

In the step of dissolving S2, the vanadium-containing mixture can be dissolved in an aqueous sulfuric acid solution. The vanadium (IV) oxide (V₂O₄) and the vanadium (III) oxide (V₂O₃) in the vanadium-containing mixture are dissolved to form vanadium (IV) ion (V⁴⁺; in the form of vanadyl ion (VO²⁺)) and vanadium (III) ion (V³⁺) according to chemical equations (V) and (VI), respectively, and the vanadium electrolyte can be therefore obtained. At this time, since the vanadium-containing mixture contains vanadium (IV) oxide (V₂O₄) and vanadium (III) oxide (V₂O₃) with a molar ratio of approximately 1:1, a molar ratio of vanadium (IV) ion (V⁴⁺) and vanadium (III) ion (V³⁺) obtained by dissolving the vanadium-containing mixture is also approximately 1:1.

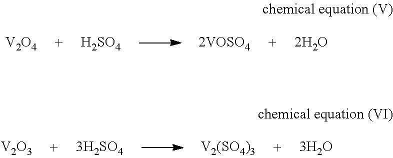

In the first embodiment according to the present invention, in order to improve the solubility of the vanadium-containing mixture, the aqueous sulfuric acid solution can have a sulfuric acid concentration of from 3 M to 6 M, and the aqueous sulfuric acid solution can preferably have a sulfuric acid concentration of equal to or greater than 4 M. Moreover, the dissolving of the vanadium-containing mixture in the aqueous sulfuric acid solution can be carried out at a temperature of from 60° C. to 90° C., and the dissolving of the vanadium-containing mixture in the aqueous sulfuric acid solution can be preferably carried out at a temperature of equal to or greater than 80° C. Furthermore, the dissolving of the vanadium-containing mixture in the aqueous sulfuric acid solution can be carried out for a time period of from 1 hour to 5 hours, and the dissolving of the vanadium-containing mixture in the aqueous sulfuric acid solution can be preferably carried out for a time period of equal to or greater than 3 hours.

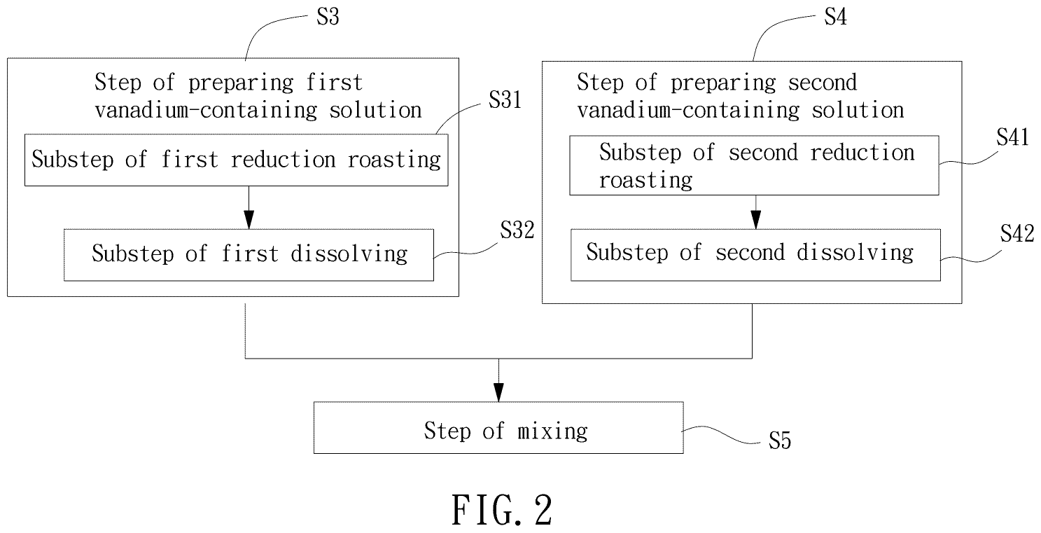

It is worthy to note that the reduction roasting reaction uses the ammonia gas (NH_{3(g)}), which is generated by heating ammonium trioxovanadate (V) (NH₄VO₃), as the reducing agent, and the ammonia gas (NH_{3(g})) actually has poor reducing ability. Therefore, the parameters of the reduction roasting reaction may be difficult to control, and the average valence of the vanadium ion of the vanadium electrolyte obtained by the method for manufacturing the vanadium electrolyte according to the first embodiment of the present invention may easily deviate from the expected value. Accordingly, a method for manufacturing the vanadium electrolyte according to the second embodiment of the present invention can be preferably carried out. Referring to FIG. 2, the method for manufacturing the vanadium electrolyte according to the second embodiment of the present invention can comprise a step of preparing a first vanadium-containing solution S3, a step of preparing a second vanadium-containing solution S4 and a step of mixing S5. As such, a first vanadium-containing solution containing vanadium (III) ion (V³⁺) and a second vanadium-containing solution containing vanadium (IV) ion (V⁴⁺) can be respectively prepared by ammonium trioxovanadate (V) (NH₄VO₃) as a raw material. Then, the first vanadium-containing solution and the second vanadium-containing solution can be mixed to produce the vanadium electrolyte.

The step of preparing the first vanadium-containing solution S3 can include a substep of first reduction roasting S31. In the substep of first reduction roasting S31, a first reduction roasting reaction can be carried out. Ammonium trioxovanadate (V) (NH₄VO₃) is heated to generate a first vanadium-containing mixture containing vanadium (III) oxide (V₂O₃) according to chemical equations (I), (II) and (III). In the second embodiment of the present invention, the first reduction roasting reaction can be carried out at a temperature of from 700° C. to 900° C. for a time period of from 1 hour to 4 hours. Preferably, the first reduction roasting reaction can be carried out at a temperature of equal to or greater than 800° C., or the first reduction roasting reaction can be carried out for a time period of equal to or greater than 3 hours.

The step of preparing a first vanadium-containing solution S3 can include a substep of first dissolving S32. In the substep of first dissolving S32, the first vanadium-containing mixture can be dissolved in a first aqueous sulfuric acid solution. Vanadium (IV) oxide (V₂O₄) and vanadium (III) oxide (V₂O₃) in the first vanadium-containing mixture are dissolved to form vanadium (IV) ion (V⁴⁺; in the form of vanadyl ion (VO²⁺)) and vanadium (III) ion (V³⁺) according to chemical equations (V) and (VI), respectively, and the first vanadium-containing solution can be therefore obtained. In the second embodiment of the present invention, the first aqueous sulfuric acid solution can have a sulfuric acid concentration of from 3 M to 6 M, and the first aqueous sulfuric acid solution can have a sulfuric acid concentration of equal to or greater than 4 M. Moreover, the dissolving of the first vanadium-containing mixture in the first aqueous sulfuric acid solution can be carried out at a temperature of from 60° C. to 90° C., and the dissolving of the first vanadium-containing mixture in the first aqueous sulfuric acid solution can be preferably carried out at a temperature of equal to or greater than 80° C. Furthermore, the dissolving of the first vanadium-containing mixture in the first aqueous sulfuric acid solution can be carried out for a time period of from 1 hour to 5 hours, and the dissolving of the first vanadium-containing mixture in the first aqueous sulfuric acid solution can be preferably carried out for a time period of equal to or greater than 3 hours.

The step of preparing a second vanadium-containing solution S4 can include a substep of second reduction roasting S41. In the substep of second reduction roasting S41, a second reduction roasting reaction can be carried out. Ammonium trioxovanadate (V) (NH₄VO₃) is heated to generate a second vanadium-containing mixture mainly composed of vanadium (IV) oxide (V₂O₄) according to chemical equations (I), (II) and (III). That is, in the second vanadium-containing mixture which includes vanadium (IV) oxide (V₂O₄) and vanadium (V) oxide (V₂O₅), the proportion of vanadium (IV) oxide (V₂O₄) is higher than the proportion of vanadium (V) oxide (V₂O₅), and in the second vanadium-containing mixture which includes vanadium (IV) oxide (V₂O₄) and vanadium (III) oxide (V₂O₃), the proportion of vanadium (IV) oxide (V₂O₄) is higher than the proportion of vanadium (III) oxide (V₂O₃). In the second embodiment of the present invention, the second reduction roasting reaction can be carried out at a temperature of from 500° C. to 700° C. for a time period of from 1 hour to 4 hours. Preferably, the second reduction roasting reaction can be carried out at a temperature of equal to or greater than 600° C., or the second reduction roasting reaction can be carried out for a time period of equal to or greater than 2 hours.

The step of preparing a second vanadium-containing solution S4 can further include a substep of second dissolving S42. In the substep of second dissolving S42, the second vanadium-containing mixture can be dissolved in a second aqueous sulfuric acid solution. Vanadium (IV) oxide (V₂O₄) and vanadium (V) oxide (V₂O₅) in the second vanadium-containing mixture are dissolved to form vanadium (IV) ion (V⁴⁺; in the form of vanadyl ion (VO²⁺)) and vanadium (V) ion (V⁵⁺; in the form on dioxovanadium (V) ion (VO₂⁺)) according to chemical equations (V) and (VII), respectively. Alternatively, vanadium (IV) oxide (V₂O₄) and vanadium (III) oxide (V₂O₃) in the second vanadium-containing mixture are dissolved to form vanadium (IV) ion (V⁴⁺; in the form of vanadyl ion (VO²⁺)) and vanadium (III) ion (V³⁺) according to chemical equations (V) and (VI). The second vanadium-containing solution can be therefore obtained. In the second embodiment of the present invention, the second aqueous sulfuric acid solution can have a sulfuric acid concentration of from 3 M to 6 M, and the second aqueous sulfuric acid solution can have a sulfuric acid concentration of equal to or greater than 4 M. Moreover, the dissolving of the second vanadium-containing mixture in the second aqueous sulfuric acid solution can be carried out at a temperature of from 60° C. to 90° C., and the dissolving of the second vanadium-containing mixture in the second aqueous sulfuric acid solution can be preferably carried out at a temperature of equal to or greater than 80° C. Furthermore, the dissolving of the second vanadium-containing mixture in the second aqueous sulfuric acid solution can be carried out for a time period of from 1 hour to 4 hours, and the dissolving of the second vanadium-containing mixture in the second aqueous sulfuric acid solution can be preferably carried out for a time period of equal to or greater than 2 hours.

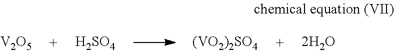

After obtaining the first vanadium-containing solution and the second vanadium-containing solution, the step of mixing S5 can be carried out to obtain the vanadium electrolyte by mixing the first vanadium-containing solution and the second vanadium-containing solution.

In order to ensure the molar ratio of vanadium (III) ion (V³⁺) and vanadium (IV) ion (V⁴⁺) in the obtained vanadium electrolyte, average valence of the vanadium ion of the first vanadium-containing solution and average valence of the vanadium ion of the second vanadium-containing solution are preferably measured to calculate a predetermined mixing ratio between the first vanadium-containing solution and the second vanadium-containing solution. Finally, the vanadium electrolyte is obtained by mixing the first vanadium-containing solution and the second vanadium-containing solution according to the predetermined mixing ratio. For example, when the average valence of the vanadium ion of the first vanadium-containing solution is 3.0, and the average valence of the vanadium ion of the second vanadium-containing solution is 4.0, the first vanadium-containing solution and the second vanadium-containing solution can be mixed at a volume ratio of 1:1. When the average valence of the vanadium ion of the first vanadium-containing solution is 3.3, and the average valence of the vanadium ion of the second vanadium-containing solution is 4.1, the first vanadium-containing solution and the second vanadium-containing solution can be mixed at a volume ratio of 3:1. When the average valence of the vanadium ion of the first vanadium-containing solution is 3.1, and the average valence of the vanadium ion of the second vanadium-containing solution is 4.2, the first vanadium-containing solution and the second vanadium-containing solution can be mixed at a volume ratio of 7:4. Accordingly, the vanadium electrolyte with a molar ratio of vanadium (III) ion (V³⁺) and vanadium (IV) ion (V⁴⁺) being approximately 1:1 can be obtained. (That is, the average valence of the vanadium ion of the vanadium electrolyte is approximately 3.5).

To evaluate the vanadium electrolyte can be obtained according to the method for manufacturing the vanadium electrolyte, the following trials are carried out:

### Trial (A).

In trial (A), ammonium trioxovanadate (V) (NH₄VO₃; 1,000 grams) is placed in a closed reduction furnace, and the first reduction roasting reaction is carried out at a temperature of from 700° C. to 900° C. for a time period of 3 hours. The obtained first vanadium-containing mixture is dissolved in the first aqueous sulfuric acid solution (5 M) at a temperature of 80° C. for a time period of 4 hours. Undissolved first vanadium-containing mixture is removed, and the molar percentages of vanadium (III) ion (V³⁺) vanadium (IV) ion (V⁴⁺; in the form of VO²⁺) and vanadium (V) ion (V⁵⁺; in the form on VO₂⁺) in the obtained first vanadium-containing solution are calculated by redox titration.

TABLE 1

| | | Molar percentage of |
|---|---|---|
| | | V³⁺, VO²⁺ and VO₂⁺ in |
| | | the first |
| | Temperature of the | vanadium-containing |
| | first reduction roasting | solution |
| Group | reaction | (V³⁺:VO²⁺:VO₂⁺) |
| A1 | 700° C. | 5.0%:95.0%:0% |
| A2 | 750° C. | 18.0%:82.0%:0% |
| A3 | 800° C. | 63.0%:37.0%:0% |
| A4 | 850° C. | 65.0%:35.0%:0% |
| A5 | 900° C. | 69.0%:31.0%:0% |

Referring to TABLE 1, by the first reduction roasting reaction carried out at a temperature of from 700° C. to 900° C. for a time period of 3 hours, ammonium trioxovanadate (V) (NH₄VO₃) can be reduced to form vanadium (III) oxide (V₂O₃) (groups A1 to A5), among which the first reduction roasting reaction carried out at a temperature of from 800° C. to 900° C. for a time period of 3 hours shows a better result (groups A3 to A5, the major proportion of the vanadium-containing compounds in the obtained first vanadium-containing mixture is vanadium (III) oxide (V₂O₃)), and the first reduction roasting reaction carried out at a temperature of 850° C. for a time period of 3 hours shows the best result (group A4).

### Trial (B).

In trial (B), ammonium trioxovanadate (V) (NH₄VO₃; 1,000 grams) is placed in the closed reduction furnace, and the first reduction roasting reaction at a temperature of 850° C. for a time period of from 1 hour to 4 hours. The obtained first vanadium-containing mixture is dissolved in the first aqueous sulfuric acid solution (5 M) at a temperature of 80° C. for a time period of 4 hours. Undissolved first vanadium-containing mixture is removed, and the molar percentages of vanadium (III) ion (V³⁺), vanadium (IV) ion (V⁴⁺; in the form of VO²⁺) and vanadium (V) ion (V⁵⁺; in the form on VO₂⁺) in the obtained first vanadium-containing solution are calculated by redox titration.

TABLE 2

| | | Molar percentage of |
|---|---|---|
| | | V³⁺, VO²⁺ and VO₂⁺ in |
| | | the first |
| | Time period of the | vanadium-containing |
| | first reduction roasting | solution |
| Group | reaction | (V³⁺:VO²⁺:VO₂⁺) |
| B1 | 1 hour | 38.0%:62.0%:0% |
| B2 | 2 hours | 40.0%:60.0%:0% |
| B3 | 3 hours | 65.0%:35.0%:0% |
| B4 | 4 hours | 63.0%:37.0%:0% |

Referring to TABLE 2, by the first reduction roasting reaction carried out at a temperature of 850° C. for a time period of from 1 hour to 4 hours, ammonium trioxovanadate (V) (NH₄VO₃) can be reduced to form vanadium (III) oxide (V₂O₃) (groups B1 to B4), among which the first reduction roasting reaction carried out at a temperature of 850° C. for a time period of from 3 hours to 4 hours shows a better result (groups B3 to B4, the major proportion of the vanadium-containing compounds in the obtained first vanadium-containing mixture is vanadium (III) oxide (V₂O₃)), and the first reduction roasting reaction carried out at a temperature of 850° C. for a time period of 3 hours shows the best result (group B3).

### Trial (C).

In trial (C), ammonium trioxovanadate (V) (NH₄VO₃; 1,000 grams) is placed in a closed reduction furnace, and the first reduction roasting reaction is carried out at a temperature of 850° C. for a time period of 3 hours. The obtained first vanadium-containing mixture is dissolved in the first aqueous sulfuric acid solution (3 M to 6 M) at a temperature of 80° C. for a time period of 4 hours. Undissolved first vanadium-containing mixture is collected, and the solubility of the first vanadium-containing mixture in the first aqueous sulfuric acid solution is calculated, accordingly.

TABLE 3

| | Sulfuric acid | |
|---|---|---|
| | concentration of the | |
| | first aqueous sulfuric | |
| | acid solution for | |
| | dissolving the first | Solubility of the first |
| | vanadium-containing | vanadium-containing |
| Group | mixture | mixture |
| C1 | 3M | 87.8% |
| C2 | 4M | 91.3% |
| C3 | 5M | 99.6% |
| C4 | 6M | 99.6% |

Referring to TABLE 3, the first vanadium-containing mixture can be effectively dissolved in the first aqueous sulfuric acid solution with a sulfuric acid concentration of from 3 M to 6 M at a temperature of 80° C. for a time period of 4 hours (groups C1 to C4), among which the first vanadium-containing mixture shows a better solubility in the first aqueous sulfuric acid solution with a sulfuric acid concentration of from 4 M to 6 M (groups C2 to C4, the solubility of the first vanadium-containing mixture reaches equal to or greater than 90%), and the first vanadium-containing mixture shows the best solubility in the first aqueous sulfuric acid solution with a sulfuric acid concentration of from 5 M to 6 M (groups C3 to C4, the solubility of the first vanadium-containing mixture reaches equal to or greater than 99%). Taking the cost and error range into consideration, the first aqueous sulfuric acid with a sulfuric acid concentration of 5 M shows the best result (group C3).

### Trial (D).

In trial (D), ammonium trioxovanadate (V) (NH₄VO₃; 1,000 grams) is placed in a closed reduction furnace, and the first reduction roasting reaction is carried out at a temperature of 850° C. for a time period of 3 hours. The obtained first vanadium-containing mixture is dissolved in the first aqueous sulfuric acid solution (5 M) at a temperature of from 60° C. to 90° C. for a time period of 4 hours. Undissolved first vanadium-containing mixture is collected, and the solubility of the first vanadium-containing mixture in the first aqueous sulfuric acid solution is calculated, accordingly.

TABLE 4

| | Temperature for | |
|---|---|---|
| | dissolving the first | Solubility of the first |
| | vanadium-containing | vanadium-containing |
| Group | mixture | mixture |
| D1 | 60° C. | 81.0% |
| D2 | 70° C. | 84.8% |
| D3 | 80° C. | 99.6% |
| D4 | 90° C. | 99.6% |

Referring to TABLE 4, the first vanadium-containing mixture can be effectively dissolved in the first aqueous sulfuric acid solution with a sulfuric acid concentration of 5 M at a temperature of from 60° C. to 90° C. for a time period of 4 hours (groups D1 to D4), among which the first vanadium-containing mixture shows a better solubility at a temperature of from 80° C. to 90° C. (groups D3 to D4, the solubility of the first vanadium-containing mixture reaches equal to or greater than 99%). Taking the cost and error range into consideration, 80° C. shows the best result (group D3).

### Trial (E).

In trial (E), ammonium trioxovanadate (V) (NH₄VO₃; 1,000 grams) is placed in a closed reduction furnace, and the first reduction roasting reaction is carried out at a temperature of 850° C. for a time period of 3 hours. The obtained first vanadium-containing mixture is dissolved in the first aqueous sulfuric acid solution (5 M) at a temperature of 80° C. for a time period of from 1 hour to 5 hours. Undissolved first vanadium-containing mixture is collected, and the solubility of the first vanadium-containing mixture in the first aqueous sulfuric acid solution is calculated, accordingly.

TABLE 5

| | Time for dissolving | |
|---|---|---|
| | the first | Solubility of the first |
| | vanadium-containing | vanadium-containing |
| Group | mixture | mixture |
| E1 | 1 hour | 76.0% |
| E2 | 2 hours | 82.2% |
| E3 | 3 hours | 92.2% |
| E4 | 4 hours | 99.6% |
| E5 | 5 hours | 99.7% |

Referring to TABLE 5, the first vanadium-containing mixture can be effectively dissolved in the first aqueous sulfuric acid solution with a sulfuric acid concentration of 5 M at a temperature of 80° C. for a time period of from 1 hour to 5 hours (groups E1 to E5), among which the first vanadium-containing mixture shows a better solubility for a time period of from 3 hours to 5 hours (groups E3 to E5, the solubility of the first vanadium-containing mixture reaches equal to or greater than 90%), and the first vanadium-containing mixture shows the best solubility for a time period of from 4 hours to 5 hours (groups E4 to E5, the solubility of the first vanadium-containing mixture reaches equal to or greater than 99%). Taking the cost and error range into consideration, 4 hours show the best result (group E4).

### Trial (F).

In trial (F), ammonium trioxovanadate (V) (NH₄VO₃; 1,000 grams) is placed in a closed reduction furnace, and the second reduction roasting reaction is carried out at a temperature of from 500° C. to 700° C. for time period of 2 hours. The obtained second vanadium-containing is dissolved in the second aqueous sulfuric acid solution (5 M) at a temperature of 80° C. for a time period of 3 hours. Undissolved second vanadium-containing mixture is removed, and the molar percentages of vanadium (III) ion (V³⁺), vanadium (IV) ion (V⁴⁺; in the form of VO²⁺) and vanadium (V) ion (V⁵⁺; in the form on VO₂⁺) in the obtained second vanadium-containing solution are calculated by redox titration.

TABLE 6

| | | Molar percentage of |
|---|---|---|
| | | V³⁺, VO²⁺ and VO₂⁺ in |
| | | the second |
| | Temperature of the | vanadium-containing |
| | second reduction | solution |
| Group | roasting reaction | (V³⁺:VO²⁺:VO₂⁺) |
| F1 | 500° C. | 0%:75.9%:24.1% |
| F2 | 550° C. | 0%:88.9%:11.1% |
| F3 | 600° C. | 0%:90.0%:10.0% |
| F4 | 650° C. | 0%:99.7%:0.3% |
| F5 | 700° C. | 8.8%:91.2%:0% |

Referring to TABLE 6, by the second reduction roasting reaction carried out at a temperature of from 500° C. to 700° C. for a time period of 2 hours, ammonium trioxovanadate (V) (NH₄VO₃) can be reduced to form vanadium (IV) oxide (V₂O₄), which is the highest proportion among all vanadium-containing compounds in the obtained second vanadium-containing mixture (groups F1 to F5), among which the second reduction roasting reaction carried out at a temperature of from 600° C. to 700° C. for a time period of 2 hours shows a better result (groups F3 to F5, the proportion of vanadium (IV) oxide (V₂O₄) reaches equal to or greater than 90%), and the second reduction roasting reaction carried out at a temperature of 650° C. for a time period of 2 hours shows the best result (group F4).

### Trial (G).

In trial (G), ammonium trioxovanadate (V) (NH₄VO₃; 1,000 grams) is placed in a closed reduction furnace, and the second roasting reaction is carried out at a temperature of 650° C. for a time period of from 1 hour to 4 hours. The obtained second vanadium-containing is dissolved in the second aqueous sulfuric acid solution (5 M) at a temperature of 80° C. for a time period of 3 hours. Undissolved second vanadium-containing mixture is removed, and the molar percentages of vanadium (III) ion (V³⁺), vanadium (IV) ion (V⁴⁺; in the form of VO²⁺) and vanadium (V) ion (V⁵⁺; in the form on VO₂⁺) in the obtained second vanadium-containing solution are calculated by redox titration.

TABLE 7

| | | Molar percentage of |
|---|---|---|
| | | V³⁺, VO²⁺ and VO₂⁺ in |
| | | the second |
| | Time of the second | vanadium-containing |
| | reduction roasting | solution |
| Group | reaction | (V³⁺:VO²⁺:VO₂⁺) |
| G1 | 1 hour | 0%:85.9%:14.1% |
| G2 | 2 hours | 0%:99.7%:0.3% |
| G3 | 3 hours | 0%:99.2%:0.8% |
| G4 | 4 hours | 0%:99.4%:0.6% |

Referring to TABLE 7, by the second reduction roasting reaction carried out at a temperature of 650° C. for a time period of from 1 hour to 4 hours ammonium trioxovanadate (V) (NH₄VO₃) can be reduced to form vanadium (IV) oxide (V₂O₄), which is the highest proportion among all vanadium-containing compounds in the obtained second vanadium-containing mixture (groups G1 to G4), among which the second reduction roasting reaction carried out at a temperature of 650° C. for a time period of from 2 hours to 4 hours shows a better result (groups G2 to G4, the proportion of vanadium (IV) oxide (V₂O₄) reaches equal to or greater than 90%), and the second reduction roasting reaction carried out at a temperature of 650° C. for a time period of 2 hours shows the best result (group G2).

### Trial (H).

In trial (H), ammonium trioxovanadate (V) (NH₄VO₃; 1,000 grams) is placed in a closed reduction furnace, and the second roasting reaction is carried out at a temperature of 650° C. for a time period of 2 hours. The obtained second vanadium-containing mixture is dissolved in the second aqueous sulfuric acid solution (3 M to 6 M) at a temperature of 80° C. for a time period of 3 hours. Undissolved second vanadium-containing mixture is collected, and the solubility of the second vanadium-containing mixture in the second aqueous sulfuric acid solution is calculated, accordingly.

TABLE 8

| | Sulfuric acid | |
|---|---|---|
| | concentration of the | |
| | second aqueous | |
| | sulfuric acid solution | |
| | for dissolving the | Solubility of the |
| | second | second |
| | vanadium-containing | vanadium-containing |
| Group | mixture | mixture |
| H1 | 3M | 85.8% |
| H2 | 4M | 95.8% |
| H3 | 5M | 99.8% |
| H4 | 6M | 99.9% |

Referring to TABLE 8, the second vanadium-containing mixture can be effectively dissolved in the second aqueous sulfuric acid with a sulfuric acid concentration of from 3M to 6 M at a temperature of 80° C. for a time period of 4 hours (groups H1 to H4), among which the second vanadium-containing mixture shows a better solubility in the second aqueous sulfuric acid solution with a sulfuric acid concentration of from 4 M to 6 M (groups H2 to H4, the solubility of the second vanadium-containing mixture reaches equal to or greater than 90%), and the second vanadium-containing mixture shows the best solubility in the second aqueous sulfuric acid solution with a sulfuric acid concentration of from 5 M to 6 M (groups H3 to H4, the solubility of the second vanadium-containing mixture reaches equal to or greater than 99%). Taking the cost and error range into consideration, the second aqueous sulfuric acid solution with a sulfuric acid concentration of 5 M shows the best result (group H3).

### Trial (I).

In trial (I), ammonium trioxovanadate (V) (NH₄VO₃; 1,000 grams) is placed in a closed reduction furnace, and the second roasting reaction is carried out at a temperature of 650° C. for a time period of 2 hours. The obtained second vanadium-containing mixture is dissolved in the first aqueous sulfuric acid solution (5 M) at a temperature of from 60° C. to 90° C. for a time period of 3 hours. Undissolved second vanadium-containing mixture is collected, and the solubility of the second vanadium-containing mixture in the second aqueous sulfuric acid solution is calculated, accordingly.

TABLE 9

| | Temperature for | Solubility of the |
|---|---|---|
| | dissolving the second | second |
| | vanadium-containing | vanadium-containing |
| Group | mixture | mixture |
| I1 | 60° C. | 90.5% |
| I2 | 70° C. | 95.8% |
| I3 | 80° C. | 99.8% |
| I4 | 90° C. | 99.8% |

Referring to TABLE 9, the second vanadium-containing mixture can be effectively dissolved in the second aqueous sulfuric acid solution at a temperature of from 60° C. to 90° C. for a time period of 3 hours (groups I1 to I4), among which the second vanadium-containing mixture shows a better solubility at a temperature of from 80° C. to 90° C. (groups I3 to I4, the solubility of the second vanadium-containing mixture reaches equal to or greater than 99%). Taking the cost and error range into consideration, 80° C. shows the best result (group I3).

### Trial (J).

In trial (J), ammonium trioxovanadate (V) (NH₄VO₃; 1,000 grams) is placed in a closed reduction furnace, and the second roasting reaction is carried out at a temperature of 650° C. for a time period of 2 hours. The obtained second vanadium-containing mixture is dissolved in the second aqueous sulfuric acid solution (5 M) at a temperature of 80° C. for a time period of from 1 hour to 4 hours. Undissolved second vanadium-containing mixture is collected, and the solubility of the second vanadium-containing mixture in the second aqueous sulfuric acid solution is calculated, accordingly.

TABLE 10

| | Time for dissolving | Solubility of the |
|---|---|---|
| | the second | second |
| | vanadium-containing | vanadium-containing |
| Group | mixture | mixture |
| J1 | 1 hour | 86.6% |
| J2 | 2 hours | 93.2% |
| J3 | 3 hours | 99.8% |
| J4 | 4 hours | 99.9% |

Referring to TABLE 10, the second vanadium-containing mixture can be effectively dissolved in the second aqueous sulfuric acid with a sulfuric acid concentration of 5 M at a temperature of 80° C. for a time period of from 1 hour to 4 hours (groups J1 to J5), among which the second vanadium-containing mixture shows a better solubility for a time period of from 2 hours to 4 hours (groups J2 to J4, the solubility of the second vanadium-containing mixture reaches equal to or greater than 90%), and the second vanadium-containing mixture shows the best solubility for a time period of from 3 hours to 4 hours (groups J3 to J4, the solubility of the second vanadium-containing mixture reaches equal to or greater than 99%). Taking the cost and error range into consideration, 3 hours show the best result (group J3).

### Trial (K).

According to the results of aforementioned trials, in trial (K), the first vanadium-containing solution of group D3 (with 65.0% of vanadium (III) ion (V³⁺) and 35.0% of vanadium (IV) ion (V⁴⁺), and thus the average valence of the vanadium ion is 3.350) and the second vanadium-containing solution of group I3 (with 99.7% of vanadium (IV) ion (V⁴⁺) and 0.3% of vanadium (V) ion (V⁵⁺), and thus the average valence of the vanadium ion is 4.003) are used.

The second vanadium-containing solution of group I3 as the adjusting solution is added to 1,000 mL of the first vanadium-containing solution of group D3. After adding 298 mL of the second vanadium-containing solution of group I3, the obtained mixture has the average valence of the vanadium ion of approximately 3.5 by redox titration, indicating that the vanadium electrolyte with the molar ratio of vanadium (III) ion (V³⁺) and vanadium (IV) ion (V⁴⁺) of approximately 1:1 can be obtained by the method for manufacturing the vanadium electrolyte.

Accordingly, in the method for manufacturing the vanadium electrolyte according to the present invention, by the use of ammonium trioxovanadate (V) (NH₄VO₃), which is cheaper than vanadium (V) oxide (V₂O₅), vanadium (IV) oxide (V₂O₄) and/or vanadium (III) oxide (V₂O₃) can be formed by the reduction roasting reaction. Vanadium (IV) oxide (V₂O₄) and/or vanadium (III) oxide (V₂O₃) can be further dissolved in the aqueous sulfuric acid solution to form the vanadium electrolyte. As such, the manufacturing cost of the vanadium electrolyte can be reduced.

Moreover, in the method for manufacturing the vanadium electrolyte according to the present invention, vanadium (V) oxide (V₂O₅) formed by heating ammonium trioxovanadate (V) (NH₄VO₃) can be reduced by ammonia gas (NH_{3(g})) formed by heating ammonium trioxovanadate (V) (NH₄VO₃) as the reducing agent, and thus, no additional reducing agent is required in the method for manufacturing the vanadium electrolyte according to the present invention. Therefore, it is possible to avoid the impurities caused by the addition of additional reducing agents, and thereby improving the quality of the vanadium electrolyte.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A method for manufacturing a vanadium electrolyte, comprising:
carrying out a reduction roasting reaction of ammonium trioxovanadate (V) (NH₄VO₃) at a temperature of from 700° C. to 900° C. for a time period of 1 hour to 4 hours, obtaining a vanadium-containing mixture; and
dissolving the vanadium-containing mixture in an aqueous sulfuric acid solution to obtain the vanadium electrolyte.

2. The method for manufacturing the vanadium electrolyte as claimed in claim 1, wherein the reduction roasting is carried out at a temperature equal to or greater than 800° C.

3. The method for manufacturing the vanadium electrolyte as claimed in claim 1, wherein the reduction roasting is carried out for a time period of equal to or greater than 3 hours.

4. The method for manufacturing the vanadium electrolyte as claimed in claim 1, wherein the reduction roasting is carried out at a temperature of 850° C. for a time period of 3 hours.

5. The method for manufacturing the vanadium electrolyte as claimed in claim 1, wherein the aqueous sulfuric acid solution has a sulfuric acid concentration of from 3 M to 6 M.

6. The method for manufacturing the vanadium electrolyte as claimed in claim 5, wherein the aqueous sulfuric acid solution has a sulfuric acid concentration of equal to or greater than 4 M.

7. The method for manufacturing the vanadium electrolyte as claimed in claim 1, wherein the vanadium-containing mixture is dissolved in the aqueous sulfuric acid solution at a temperature of from 60° C. to 90° C.

8. The method for manufacturing the vanadium electrolyte as claimed in claim 7, wherein the vanadium-containing mixture is dissolved in the aqueous sulfuric acid solution at a temperature of equal to or greater than 80° C.

9. The method for manufacturing the vanadium electrolyte as claimed in claim 1, wherein the vanadium-containing mixture is dissolved in the aqueous sulfuric acid solution for a time period of from 1 hour to 5 hours.

10. The method for manufacturing the vanadium electrolyte as claimed in claim 9, wherein the vanadium-containing mixture is dissolved in the aqueous sulfuric acid solution for a time period of equal to or greater than 3 hours.

11. A method for manufacturing a vanadium electrolyte, comprising:
carrying out a first reduction roasting reaction of ammonium trioxovanadate (V) (NH₄VO₃) at a temperature of from 700° C. to 900° C. for a time period of from 1 hour to 4 hours, obtaining a first vanadium-containing mixture;
dissolving the first vanadium-containing mixture in a first aqueous sulfuric acid solution, obtaining a first vanadium-containing solution;
carrying out a second reduction roasting reaction of ammonium trioxovanadate (V) (NH₄VO₃) at a temperature of from 500° C. to 700° C. for a time period of from 1 hour to 4 hours, obtaining a second vanadium-containing mixture;
dissolving the second vanadium-containing mixture in a second aqueous sulfuric acid solution, obtaining a second vanadium-containing solution; and
mixing the first vanadium-containing solution and the second vanadium-containing solution to obtain the vanadium electrolyte.

12. The method for manufacturing the vanadium electrolyte as claimed in claim 11, further comprising: measuring average valence of the vanadium ion of the first vanadium-containing solution and average valence of the vanadium ion of the second vanadium-containing solution to calculate a predetermined mixing ratio between the first vanadium-containing solution and the second vanadium-containing solution; and mixing the first vanadium-containing solution and the second vanadium-containing solution according to the predetermined mixing ratio to obtain the vanadium electrolyte.

13. The method for manufacturing the vanadium electrolyte as claimed in claim 11, wherein the first reduction roasting reaction is carried out at a temperature of equal to or greater than 800° C.

14. The method for manufacturing the vanadium electrolyte as claimed in claim 11, wherein the first reduction roasting reaction is carried out for a time period of equal to or greater than 3 hours.

15. The method for manufacturing the vanadium electrolyte as claimed in claim 11, wherein the first reduction roasting reaction is carried out at a temperature of 850° C. for a time period of 3 hours.

16. The method for manufacturing the vanadium electrolyte as claimed in claim 11, wherein the first aqueous sulfuric acid solution has a sulfuric acid concentration of from 3 M to 6 M.

17. The method for manufacturing the vanadium electrolyte as claimed in claim 16, wherein the first aqueous sulfuric acid solution has a sulfuric acid concentration of equal to or greater than 4 M.

18. The method for manufacturing the vanadium electrolyte as claimed in claim 11, wherein the first vanadium-containing mixture is dissolved in the first aqueous sulfuric acid solution at a temperature of from 60° C. to 90° C.

19. The method for manufacturing the vanadium electrolyte as claimed in claim 18, wherein the first vanadium-containing mixture is dissolved in the first aqueous sulfuric acid solution at a temperature of equal to or greater than 80° C.

20. The method for manufacturing the vanadium electrolyte as claimed in claim 11, wherein the first vanadium-containing mixture is dissolved in the first aqueous sulfuric acid solution for a time period of from 1 hour to 5 hours.

21. The method for manufacturing the vanadium electrolyte as claimed in claim 20, wherein the first vanadium-containing mixture is dissolved in the first aqueous sulfuric acid solution for a time period of equal to or greater than 3 hours.

22. The method for manufacturing the vanadium electrolyte as claimed in claim 11, wherein the second reduction roasting reaction is carried out at a temperature of equal to or greater than 600° C.

23. The method for manufacturing the vanadium electrolyte as claimed in claim 11, wherein the second reduction roasting reaction is carried out for a time period of equal to or greater than 2 hours.

24. The method for manufacturing the vanadium electrolyte as claimed in claim 11, wherein the second reduction roasting reaction is carried out at a temperature of 650° C. for a time period of 2 hours.

25. The method for manufacturing the vanadium electrolyte as claimed in claim 11, wherein the second aqueous sulfuric acid solution has a sulfuric acid concentration of from 3 M to 6 M.

26. The method for manufacturing the vanadium electrolyte as claimed in claim 25, wherein the second aqueous sulfuric acid solution has a sulfuric acid concentration of equal to or greater than 4 M.

27. The method for manufacturing the vanadium electrolyte as claimed in claim 11, wherein the second vanadium-containing mixture is dissolved in the second aqueous sulfuric acid solution at a temperature of from 60° C. to 90° C.

28. The method for manufacturing the vanadium electrolyte as claimed in claim 27, wherein the second vanadium-containing mixture is dissolved in the second aqueous sulfuric acid solution at a temperature of equal to or greater than 80° C.

29. The method for manufacturing the vanadium electrolyte as claimed in claim 11, wherein the second vanadium-containing mixture is dissolved in the second aqueous sulfuric acid solution for a time period of from 1 hour to 4 hours.

30. The method for manufacturing the vanadium electrolyte as claimed in claim 29, wherein the second vanadium-containing mixture is dissolved in the second aqueous sulfuric acid solution for a time period of equal to or greater than 2 hours.
